(19) United States
(12) Patent Application Publication
(10) Pub. No.: US 2016/0123355 A1
(43) Pub. Date: May 5, 2016

(54) SERVO VALVES

(71) Applicant: BLAGDON ACTUATION RESEARCH LIMITED, Blagdon, Bristol (GB)

(72) Inventor: Andrew John COLLINS, Somerset (GB)

(73) Assignee: BLAGDON ACTUATION RESEARCH LIMITED, Blagdon, Bristol (GB)

(21) Appl. No.: 14/897,137

(22) PCT Filed: Jun. 11, 2014
(86) PCT No.: PCT/GB2014/051800

§ 371 Date: Dec. 9, 2015

(30) Foreign Application Priority Data
Jun. 12, 2013 (GB) 1310451.8

(51) Int. Cl. F15B 13/04; F15B 13/044

(52) U.S. Cl. CPC F15B 13/0406; F15B 13/0444

(57) ABSTRACT

A servo valve comprises a fluid inlet, a fluid outlet and a cylindrical spool. The spool has a surface including a curvilinear groove and is mounted for rotational movement between a first position in which the surface of the spool covers at least one of the fluid outlet and the fluid inlet and a second position in which the groove is aligned with the fluid inlet and the fluid outlet.

### TECHNICAL FIELD

The present invention concerns improvements in and relating to servo valves. More particularly, this invention concerns an improved spool design for use in a servo valve.

### BACKGROUND OF THE INVENTION

Servo valves are used in a wide variety of industries to control the movement of hydraulic or pneumatic actuators in response to an input signal and are employed in industries where precise control of an actuator is required, for example in the aerospace industry. Servo valves alter the flow of a fluid through the valve in order to control the position, velocity, acceleration or force generated by an actuator, for example a hydraulic or pneumatic cylinder or motor.

A servo valve typically comprises a moving element (spool) and a fixed element (sleeve). The relative movement of these two elements controls the flow of fluid through the valve in response to a mechanical or electrical input signal.

A servo valve typically comprises a motor which moves the spool in response to an input signal. A valve in which the motor is directly connected to the spool is known as a direct drive servo valve (DDV). The degree of precision of control that may be obtained by a DDV is a function of the relative gearing between the motor and the spool. A servo valve may also be manually controlled, in which case the degree of precision of control that may be obtained is a function of the relative gearing between the manual input and the spool.

Gearing mechanisms have been developed which allow very precise control of the relative movement of the spool and the fixed sleeve.

Gearing mechanisms such as described above allow precise control of the motion of the spool. However, such gearing mechanisms increase the complexity of the servo valve and therefore impact upon the cost, reliability and serviceability of the valve. Consequently, it would be advantageous to provide an improved servo valve which is capable of precise control whilst minimising complexity.

### SUMMARY OF THE INVENTION

According to one aspect of the invention there is provided a servo valve comprising a fluid inlet, a fluid outlet and a cylindrical spool, the spool having a surface including a curvilinear groove, wherein the spool is mounted for rotational movement between a first position in which the surface of the spool covers the fluid outlet and a second position in which the groove is aligned with the fluid inlet and the fluid outlet.

The present invention provides a simple yet effective mechanism for controlling a servo valve. The path of the curvilinear groove may be varied in order to tailor the amount of rotation of the spool required to bring the groove into alignment with the fluid inlet and the fluid outlet to a particular application. The path of the curvilinear groove may also be varied in order to tailor the change in the rate of flow (when already aligned with the fluid inlet and fluid outlet) through the groove generated in response to a given rotational movement to a particular application. For example, the greater the longitudinal distance covered by a groove for a given distance around the circumference of the spool, the more sensitive to rotation of the spool the valve will be. Thus, the gearing between the spool and motor may be optimized without having to change the dimensions of the spool and manifold. Embodiments according to this design have also been found to maximise the flow for a given control valve size (in particular a control valve of a given length).

The dimensions of the servo valve may vary quite widely according to its application. For example, the diameter of the spool may be between 1 mm and 100 mm. The length of the spool may be between 5 mm and 100 mm. The maximum flow rate through the spool may be between 1 litre per minute and 500 litres per minute.

The surface of the spool may cover the fluid outlet when the spool is in the first position. The surface of the spool may cover the fluid inlet when the spool is in the first position. The surface of the spool may cover both the fluid inlet and the fluid outlet when the spool is in the first position.

The flow path of the fluid may be as follows (in order): fluid inlet, groove, fluid outlet.

The spool may have a first end and a second end. The spool may be mounted for rotational movement around the longitudinal axis of the spool. The spool may be constrained to prevent movement along the longitudinal axis of the spool.

The groove may extend from the first end of the spool to the second end of the spool. The groove may extend along the majority of the length of the spool. The spool may be solid. Thus, the structure of the spool may be simple yet capable of withstanding the loads generated by a high-pressure fluid.

The groove may have a start point and an end point. The groove may have a length which is defined as the distance between the start and end points. The end point of the groove may be spaced apart from the start point along the longitudinal axis of the spool. Thus, the end point may be offset longitudinally with respect to the start point. The end point of the groove may be spaced apart from the start point of the groove around the circumference of the spool. Thus, the end point may be offset angularly with respect to the start point.

The groove may follow a curved path on the surface of the spool. Thus, the start point and the end point may be offset both longitudinally and angularly with respect to each other.

The groove may follow a helical path on the surface of the spool. Thus, the groove may be helical. The helical groove may have constant pitch. The helical groove may have variable pitch.

The servo valve may have a motor. The motor may be connected directly to the spool. Thus, the servo valve may be a direct drive servo valve (DDV).

The servo valve may include a fluid manifold. The fluid manifold may include a cavity. The spool may be located within the manifold cavity. The manifold cavity may be defined by an inner surface of the manifold. The manifold cavity may be substantially cylindrical. The spool may be concentrically located within the manifold cavity. The inner surface of the manifold may define a cavity and the spool may be concentrically located within the cavity. The spool may be axially constrained within the manifold cavity.

The spool may be located within the manifold cavity such that there is substantially no gap between the surface of the spool where the groove is not present and the inner surface of the manifold cavity. The majority of the surface of the spool may be in contact, as herein defined, with the inner surface of the cavity. “in contact” as herein defined means that any gap between the inner surface of the cavity and the surface of the spool is small enough that internal leakage of fluid is less than 5% of the flow through the valve. Therefore fluid flow around the spool, other than via the groove, may be prevented. Thus, contact between the spool and the inner surface of the manifold may be defined as the spool and the inner surface of the manifold being sufficiently close together to prevent significant flow between the inner surface of the cavity and the surface of the spool. For example, the clearance between the spool and the inner surface may be 5 μm or less. In this way precise control of the fluid flow through the valve is achievable, as the amount of flow is the result of the degree of alignment between the groove and the fluid inlet/outlet.

The fluid inlet may be located in the inner surface of the cavity. The fluid outlet may be located in the inner surface of the manifold cavity. Thus, the valve may include a manifold and the fluid inlet and fluid outlet may be located in an inner surface of the manifold.

The servo valve may include a sleeve. The sleeve may be located within the fluid manifold. The sleeve may be substantially cylindrical. The sleeve may be located within the manifold cavity. The sleeve may be located concentrically within the cavity. The spool may be located concentrically within the sleeve. The cavity, sleeve and spool may be concentric.

The servo valve may include a second fluid inlet. The servo valve may include a second fluid outlet. The second fluid inlet may be located on the inner surface of the manifold cavity. The second fluid outlet may be located on the inner surface of the manifold cavity. The surface of the spool may cover the second fluid inlet when the spool is in the first position. The surface of the spool may cover the second fluid outlet when the spool is in the first position. Thus, in the first position the surface of the spool may cover both the second fluid inlet and the second fluid outlet.

The surface of the spool may cover the second fluid outlet when the spool is in the second position. The surface of the spool may cover the second fluid inlet when the spool is in the second position. Thus, in the second position the surface of the spool may cover both the second fluid inlet and the second fluid outlet.

The spool may be mounted for rotational movement between the first position and a third position, in which the groove is aligned with the second fluid inlet and the second fluid outlet. Thus, the servo valve may be able to provide differing flow paths depending on the angle of rotation of the spool. For example, the manifold may be able to provide a first flow path when the spool is in the second position, and a second, different, flow path when the spool is in the third position. This increases the degree of flexibility of the manifold design and consequently the number of applications in which it may be of use. The magnitude of the angle of rotation between the first position and the second position may be in the range of 20 to 90 degrees. The magnitude of the angle of rotation between the first position and the third position may be in the range of 20 to 90 degrees. The angle of rotation between the first position and the second or third position may be a function of the layout of the curvilinear groove on the surface of the spool. For example, if the groove is helical, a larger pitch will require a smaller angle of rotation for a given inlet/outlet configuration.

The surface of the spool may cover the first fluid inlet when the spool is in the third position. The surface of the spool may cover the first fluid outlet when the spool is in the third position. Thus, in the third position the surface of the spool may cover both the first fluid inlet and the first fluid outlet.

The spool may rotate in a first direction from the first position to the second position. The spool may rotate in a second direction from the first position to the third position. The second direction may be opposite to the first direction. The spool may rotate in a first direction from the first position to the second position and a second, opposite, direction from the first position to the third position.

Each fluid outlet may be directly opposite a fluid inlet. Alternatively, it may be that no fluid outlet is directly opposite a fluid inlet. Each fluid outlet may be at 90 degrees to a fluid inlet.

The servo valve may be connected to a hydraulic system. The servo valve may control the hydraulic system. For example, the hydraulic system may be an actuator. The hydraulic system may be a hydraulic motor.

The servo valve may be connected to an actuator. The servo valve may control the actuator. The actuator may have a first chamber. The actuator may have a second chamber. The fluid outlet may be connected to the first chamber such that fluid flowing through the fluid outlet increases the pressure in the first chamber. The fluid outlet may be connected to the first chamber via a first control port. The second fluid outlet may be connected to the second chamber such that fluid flowing through the second fluid outlet increases the pressure in the second chamber. The second fluid outlet may be connected to the second chamber via a second control port. Increasing the pressure in the first chamber may cause the actuator to move in a first output direction. Increasing the pressure in the second chamber may cause the actuator to move in a second output direction. The first output direction may be opposite to the second output direction.

The servo valve may be connected to a hydraulic motor. The servo valve may control the hydraulic motor. The motor may have a first motor port. The motor may have a second motor port. The fluid outlet may be connected to the first motor port such that fluid flowing through the fluid outlet drives the hydraulic motor in a first direction. The fluid outlet may be connected to the first motor port via a first control port. The second fluid outlet may be connected to the second motor port such that fluid flowing through the second fluid outlet drives the hydraulic motor in a second direction. The second fluid outlet may be connected to the second chamber via a second control port.

The fluid inlet and fluid outlet may be referred to as internal ports. An internal port may act as both a fluid inlet and a fluid outlet. For example, an internal port may act as a fluid outlet when the spool is in the first position and act as a fluid inlet when the spool is in the third position. Thus an internal port may allow fluid to flow both to and from the first actuator chamber via the first control port. Another, different, internal port may allow fluid to flow both to and from the second actuator chamber via the second control port. Thus, the servo valve may be able to control the flow in both directions via the same internal port.

The servo valve may include a supply pressure port. Thus, a fluid inlet may be in fluid communication with the supply pressure port such that fluid at pressure may enter the groove. The supply pressure port may be connected to the fluid inlet via the manifold.

The servo valve may include a tank port. Thus, a fluid outlet may be in fluid communication with the tank port such that fluid from the groove is able to exit the servo valve to tank. The tank port may be connected to a fluid outlet via the manifold.

The servo valve may have one or more control ports. For example the servo valve may have two control ports. Each control port may be connected to an internal port such that fluid from the groove is able to exit the servo valve via the control port. Each control port may be connected to an internal port such that fluid is able to enter the groove via the control port. Each control port may be connected to an internal port such that fluid can either enter or exit the servo valve via the control port depending on the position of the spool. Thus, the servo valve may be able to control the flow of fluid both to and from a control port via the same internal port. Each control port may be connected to an internal port via the manifold.

The flow path of the fluid through the servo valve may be as follows (in order): pressurised supply port, fluid inlet (internal port), groove, fluid outlet (internal port), first control port. Alternatively, the flow path of the fluid through the servo valve may be, in order: pressurised supply port, fluid inlet (internal port), groove, second fluid outlet (internal port), second control port. Thus, if the servo valve is connected to an actuator, depending on the alignment of the groove, fluid may flow to either the first or second chamber of the actuator. Alternatively, if the servo valve is connected to a hydraulic motor, depending on the alignment of the groove, fluid may flow to either the first or second motor port.

The flow path of the fluid through the servo valve may be as follows (in order): first control port, fluid inlet (internal port), groove, fluid outlet (internal port), tank port. Alternatively, the flow path of the fluid through the servo valve may be as follows (in order): second control port, fluid inlet (internal port), groove, fluid outlet (internal port), tank port. Thus, if the servo valve is connected to an actuator, depending on the alignment of the groove, fluid is able to flow from either of the first or second actuator chambers to the outlet tank. Alternatively, if the servo valve is connected to a hydraulic motor, depending on the alignment of the groove, fluid is able to flow from either of the first or second motor ports to the outlet tank.

The surface of the spool may include a second groove. Thus the spool may provide a second flow path. The second groove may be curvilinear. Thus, the surface of the spool may include a second curvilinear groove. The second groove may be parallel to the first groove. The second groove may be a helix. Thus, the two grooves in the surface of the spool may form a double helix around the longitudinal axis of the spool.

The spool may be mounted for rotational movement between the first position and a two-flow position in which each of the first and second grooves are aligned with a fluid inlet and a fluid outlet. For example, the second groove may be aligned with a fluid inlet and a fluid outlet when the first groove is aligned with a different fluid inlet and a different fluid outlet. Thus, fluid may flow through the second groove in the opposite direction to fluid flowing through the first groove. Thus, the design of the spool may allow for simultaneous bi-directional flow. When the spool is in the second position the first groove may be aligned with the first fluid inlet and the first fluid outlet and the second groove may be aligned with the second fluid inlet and the second fluid outlet. Thus, the second position may be a two-flow position. When the spool is in the third position the first groove may be aligned with the second fluid inlet and the second fluid outlet and the second groove may be aligned with the first fluid inlet and the first fluid outlet. Thus, the third position may be a two-flow position.

Alternatively, in a two-flow position the first groove may be aligned with the first fluid inlet and the second fluid outlet and the second groove may be aligned with the second fluid inlet and the first fluid outlet. Thus fluid may flow from the pressurised supply port to one of the first or second control ports via the first groove whilst fluid from the other of the first or second control ports may flow to the tank port via the second groove.

The servo valve may include further internal ports. The servo valve may include further fluid inlets. The servo valve may include further fluid outlets. The servo valve may include further external ports. The spool may include further grooves. For example a spool may have four grooves and eight internal ports. Thus, the servo valve may be able to control the flow of fluid along multiple flow paths depending on the position of the spool.

Pressurised fluid from the fluid inlets may unbalance the spool. Consequently, the number and configuration of the internal ports and grooves of a valve may impact upon the balance of the spool within the manifold. Certain configurations of internal ports and grooves may result in a better balanced spool. For example, a spool having four grooves and eight ports may be particularly well balanced because the ports which introduce pressurized fluid can be located opposite each other.

The internal ports, external ports and grooves required to control a single hydraulic system may be referred to as a set. Each set may comprise at least a fluid inlet, a fluid outlet and a groove. Each set may further comprise two external ports. Each set may include further internal ports, grooves and external ports depending upon the nature of the hydraulic system with which it is associated. For example, each set may have four grooves and eight internal ports.

The servo valve may have more than one set. Thus, the servo valve may be configured to be connected to more than one hydraulic system. The internal ports of one set may be interspersed along the longitudinal axis of the spool with the internal ports of another set. The internal ports of each set may be grouped separately from the internal ports of any other set along the longitudinal axis of the spool. A set may overlap another set along the longitudinal axis of the spool. Each set may be spaced apart from any other set along the longitudinal axis of the spool.

A spool configured to be connected to two hydraulic systems may comprise two sets and therefore eight grooves and sixteen internal ports.

The servo valve may include a mechanical feedback device. The servo valve may include an electrical feedback device. The servo valve may be a closed loop control system. The use of a feedback device may enable the servo valve to control the actuator to a higher degree of precision.

The spool movement may be achieved indirectly via control of hydraulic pressure and flow within the valve. For example, the servo valve may be an electrohydraulic servo control valve (EHSV).

According to another aspect, the present invention provides a method of controlling a servo valve, the method comprising the steps of:
i. providing a valve including a fluid inlet, a fluid outlet and a spool having a curvilinear groove in its surface;
ii. rotating the spool from a first position in which the surface of the spool covers the fluid outlet to a second position in which the groove is aligned with the fluid inlet and the fluid outlet such that fluid flows from the fluid inlet to the fluid outlet via the groove.
   Thus, rotating the spool may allow fluid to flow through the valve and control the actuator or the hydraulic motor.

An additive manufacturing process may be used to produce the valve. Additive manufacture, also known as 3D printing, is a term applied to processes whereby three-dimensional articles are manufactured by building up successive layers of material in different shapes. This is in contrast to traditional manufacturing techniques (known as subtractive manufacturing) such as milling or boring in which material is removed from a billet in order to create the final form of an article. The additive manufacturing process may be particularly well suited to producing a valve with a spool including a curvilinear groove.

The fluid inlet may be in fluid communication with the supply pressure port. The fluid outlet may be in fluid communication with the first control port. Thus, if the servo valve is connected to an actuator, rotating the spool may allow fluid to flow from the pressurised supply to the first chamber of the actuator. Alternatively, if the servo valve is connected to a hydraulic motor, rotating the spool may allow fluid to flow from the pressurised supply to the first motor port.

The fluid inlet may be in fluid communication with the supply pressure port. The fluid outlet may be in fluid communication with the second control port. Thus, if the servo valve is connected to an actuator, rotating the spool may allow fluid to flow from the pressurised supply to the second chamber of the actuator. Alternatively, if the servo valve is connected to a hydraulic motor, rotating the spool may allow fluid to flow from the pressurised supply to the second motor port.

The fluid inlet may be in fluid communication with either of the first or second control ports. The fluid outlet may be in fluid communication with the tank port. Thus, rotating the spool may allow fluid to flow from one of the first or second control ports to the tank outlet.

The method may include one or more of the following steps:
i. rotating the spool from the second position to the first position;
ii. rotating the spool from the first position to a third position in which the groove is aligned with the second fluid inlet and the second fluid outlet such that fluid flows from the second fluid inlet to the second fluid outlet via the groove.

The spool may include a second groove. Thus, the spool may provide more than one flow path simultaneously. The method may include one or more of the following steps:
i. providing a valve having a second fluid inlet and a second fluid outlet;
ii. providing a spool having a second curvilinear groove in its surface;
iii. rotating the spool from the first position to a two-flow position in which each of the first and second grooves is aligned with both a fluid inlet and a fluid outlet.

Thus, rotating the spool may allow simultaneous bi-directional flow of fluid through the valve. The surface of the spool may cover the second fluid outlet when the spool is in the first position.

The angular position of the spool may be the same for the second position and the two-flow position. Thus, in the two-flow position the first groove may be aligned with the first fluid inlet and the first fluid outlet and the second groove may be aligned with the second fluid inlet and the second fluid outlet.

The angular position of the spool may be the same for the third position and the two-flow position. Thus, in the two-flow position the first groove may be aligned with the second fluid inlet and the second fluid outlet and the second groove may be aligned with the first fluid inlet and the first fluid outlet.

Alternatively, in the two-flow position the first groove may be aligned with the first fluid inlet and the second fluid outlet and the second groove may be aligned with the second fluid inlet and the first fluid outlet.

Any features described with reference to one aspect of the invention are equally applicable to any other aspect of the invention, and vice versa.

### DESCRIPTION OF THE DRAWINGS

An embodiment of the invention will now be described, by way of example only, with reference to the accompanying schematic drawings of which:

FIG. 1 is a schematic representation of a servo valve and actuator;

FIG. 2a is a schematic cross-sectional view of the spool and manifold of the servo valve of FIG. 1 in a first position;

FIG. 2b is a schematic cross-sectional view of the spool and manifold of the servo valve of FIG. 1 in a second position; and

FIG. 2c is a schematic cross-sectional view of the spool and manifold of the servo valve of FIG. 1 in a third position.

### DETAILED DESCRIPTION

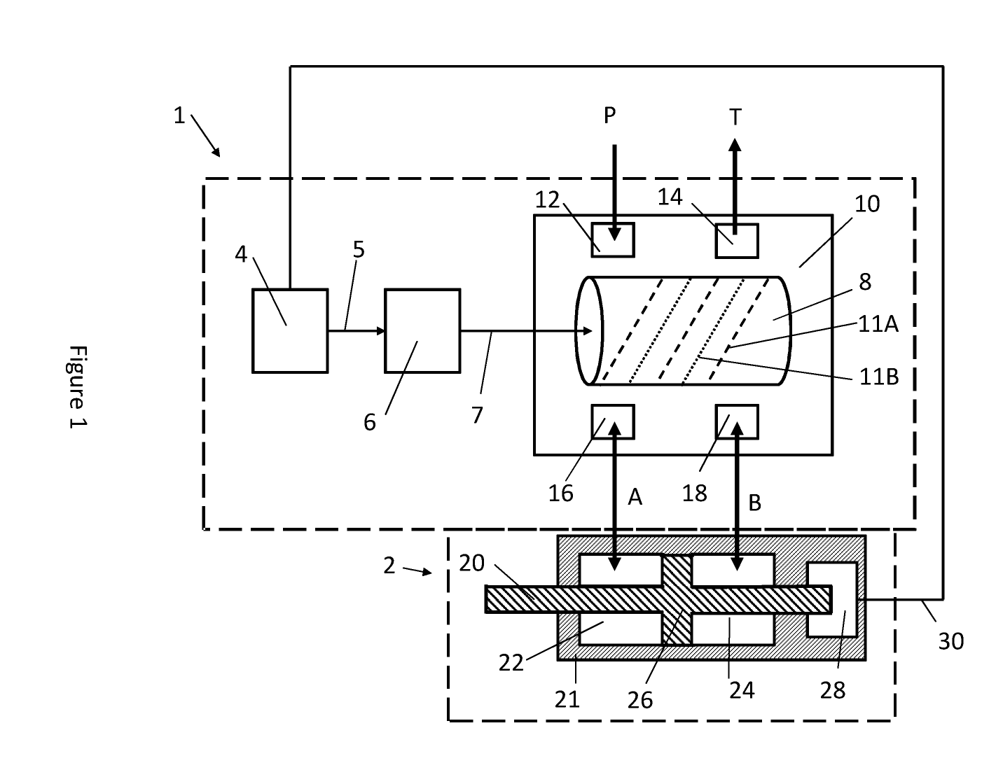

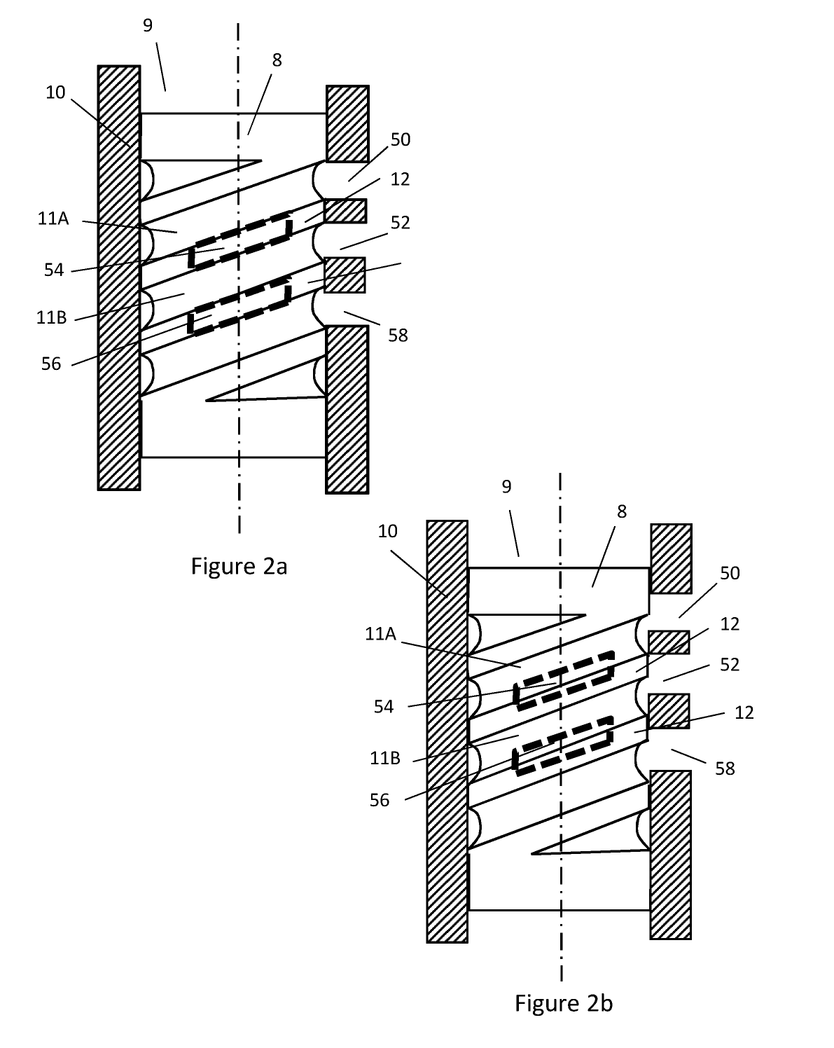

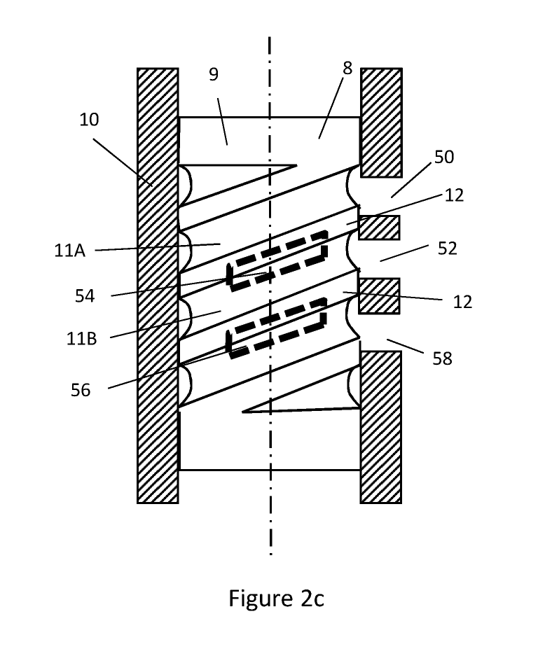

FIG. 1 shows a schematic view of a servo valve 1 and an actuator 2. The servo valve 1 includes control electronics 4, a motor 6, a spool 8 and a manifold 10. The motor is connected to the control electronics 4 by a signal line 5 and to the spool 8 by a drive shaft 7. The spool 8 is located within a cavity 9 inside the manifold 10 and is mounted for angular rotation about its longitudinal axis. The surface of the spool includes two grooves 11a and 11b (denoted by dashed and dotted lines respectively in FIG. 1). The manifold includes a supply pressure port 12, a tank outlet port 14, a first control port 16 and a second control port 18. The manifold 10 includes one or more flow galleries (not shown) linking the supply pressure port 12, which connects with a pressurised supply P, to the fluid inlet 50 (see FIG. 2) and the tank outlet port 14, which connects with an unpressurised tank T, to the fluid outlet 52 (see FIG. 2). Further flow galleries (not shown) within the manifold 10 link the first and second control ports 16, 18 with the other internal ports (see below for more details). The actuator 2 includes a cylinder 21 and an actuator arm 20. The actuator arm 20 is partially located within a hollow cylinder 21 and includes a piston 26 which divides the internal space of the cylinder 21 into a first chamber 22 and a second chamber 24. Also located within the cylinder 21 is a position transducer 28. The position transducer 28 relays its signal to the control circuitry 4 via the wiring 30. The first and second control ports 16, 18 on the manifold 10 are in fluid communication with the first and second chambers 22, 24 respectively of the cylinder 21.

In response to an input signal, the control electronics 4 drive the motor 6 via the signal line 5. The motor 6 then rotates the spool 8 about its longitudinal axis within the cavity 9 via the drive shaft 7. The rotation of the spool 8 causes the grooves 11a, 11b to move into or out of alignment with the internal ports located on the inner surface of cavity 9. When a groove 11 is aligned with a fluid inlet and a fluid outlet, fluid may flow from the pressurised supply port 12 to either of the first or second control ports 16, 18 depending on the alignment of the groove 11. Alternatively (or as well, depending on the form of the groove, see below) fluid may flow from either of the first or second control ports 16, 18 to the tank outlet port 14. The interaction of the groove, the spool and the internal ports is discussed in more detail below in relation to FIG. 2.

If the fluid flows from the servo valve 1 via the first control port 16, then the pressure in the first cylinder chamber 22 increases. The increase in pressure in the first cylinder chamber 22 acts on piston 26 to move the actuator arm 20 in a first direction. If the fluid flows from the servo valve 1 via the second control port 18, then the pressure in the second cylinder chamber 24 increases. The increase in pressure in the second cylinder chamber 24 acts on piston 26 to move the actuator arm 20 in a second direction. The position transducer 28 monitors the position of actuator arm 20 and relays this information to the control electronics 4 via the wiring 30. The control electronics 4 then compares the actual and desired position of the actuator arm 20 and adjusts the signal sent to the motor 6 accordingly.

FIG. 2a shows a cross-sectional view of the spool 8 in a first angular position. The spool 8 is located within the cavity 9 in the manifold 10. The spool has two grooves 11a, 11b which form a double helix about the longitudinal axis of the spool. The internal ports 50, 52, and 58, shown in cross section in FIG. 2a, are provided in the manifold 10. Port 52 is located between the other two ports 50 and 58. Dashed lines are used to indicate the location of the internal ports 54 and 56 which are at approximately 90 degrees to the internal ports 50, 52 and 58. The internal ports 54 and 56 are vertically aligned (as viewed in FIG. 2a) with port 54 above port 56. The first groove 11a is aligned with a port 50. The first groove 11a is also aligned with another port 58 at a location further along the groove. The second groove 11b is aligned with a port 52, which is located between the other two ports. Both ports 54 and 56 are covered by the surface 12 of the spool 8. Thus, no fluid flows through the valve in this configuration.

In this case the internal ports 50 and 58 are connected to the pressure supply port 12 via the manifold 10. Therefore ports 50 and 58 are fluid inlets. Port 52 is connected to the tank port 14 via the manifold 10. Therefore port 52 is a fluid outlet. The internal ports 54 and 56 are connected to the control ports 16 and 18 respectively. Ports 54 and 56 may be fluid inlets or outlets depending on the orientation of the spool.

FIG. 2b shows a cross-section view of the spool 8 in a second angular position. The spool 8 has been rotated about its longitudinal axis such that the groove 11a is now aligned with internal port 54, and the groove 11b is now aligned with internal port 56. It will be noted that the degree of alignment between an internal port and a given groove need only be enough to allow fluid to pass between the port and the groove. Ports 50 and 58 remain aligned with the groove 11a and port 52 remains aligned with the groove 11b. Consequently, the rotation of the spool 8 creates a flow path between a fluid inlet 50, and (in this spool orientation, a fluid outlet) port 54 via the groove 11a along which fluid may flow from the pressurised supply to the first chamber 22 of the actuator 2. The rotation of the spool 8 to the second position also creates a flow path between (in this spool orientation, a fluid inlet) port 56 and a fluid outlet 52 via the groove 11b along which fluid may flow from the second chamber 24 of the actuator 2 to the tank outlet T.

Consequently, in the second position fluid enters the first cylinder chamber 22 thereby causing the pressure inside to rise. The increased pressure on the piston 26 causes it to move. The movement of the piston 26 moves the actuator arm 20 (which is attached thereto) and also increases the pressure in the second cylinder chamber 24. The increase in pressure in the second cylinder chamber 24 causes fluid to leave the chamber 24 to the tank outlet T via the groove 11b in the spool 8.

FIG. 2c shows a cross-sectional view of the spool 8 in a further angular position. The spool 8 has been rotated in the opposite direction from the first position, away from the second position, such that the groove 11a is now aligned with internal port 56 (in the second position it was aligned with port 54), and the groove 11b is now aligned with internal port (in the second position it was aligned with port 56). Thus the two grooves have swapped the ports which are connected to the cylinder chambers with which they are aligned. Ports 50 and 58 remain aligned with the groove 11a and port 52 remains aligned with the groove 11b. Consequently, the rotation of the spool 8 creates a flow path between a fluid inlet 58, and (in this spool orientation, a fluid outlet) port 56 via the groove 11a along which fluid may flow from the pressurised supply to the second chamber 24 of the actuator 2. The rotation of the spool 8 to this position also creates a flow path between (in this spool orientation, a fluid inlet) port 54 and a fluid outlet 52 via the groove 11b along which fluid may flow from the first chamber 22 of the actuator 2 to the tank outlet T. Consequently, in the second position fluid enters the second cylinder chamber 24 thereby causing the pressure inside to rise. The increased pressure on the piston 26 causes it to move. The movement of the piston 26 moves the actuator arm 20 (which is attached thereto) and also increases pressure in the first cylinder chamber 22. The increase in pressure in the first cylinder chamber 22 causes fluid to leave the chamber to the tank outlet T via the groove 11b in the spool 8.

Whilst the present invention has been described and illustrated with reference to a particular embodiment, it will be appreciated by those of ordinary skill in the art that the invention lends itself to many different variations not specifically illustrated herein. Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. A servo valve comprising a fluid inlet, a fluid outlet and a cylindrical spool, the spool having a surface including a curvilinear groove, wherein the spool is mounted for rotational movement between a first position in which the surface of the spool covers at least one of the fluid outlet and the fluid inlet and a second position in which the groove is aligned with the fluid inlet and the fluid outlet.

2. A servo valve according to claim 1, in which the groove is helical.

3. A servo valve according to claim 1, wherein the servo valve includes a second fluid inlet and a second fluid outlet and the spool is mounted for rotational movement between the first position and a third position, in which the groove is aligned with the second fluid inlet and the second fluid outlet.

4. A servo valve according to claim 3, wherein the spool rotates in a first direction from the first position to the second position and a second, opposite, direction from the first position to the third position.

5. A servo valve according to claim 1, in which the surface of the spool includes a second curvilinear groove.

6. A servo valve according to claim 5, in which the first and second grooves are helical, and the first and second grooves form a double helix around the longitudinal axis of the spool.

7. A servo valve according to claim 1, wherein the valve further includes a manifold and the fluid inlet and fluid outlet are located in a surface of the manifold.

8. A servo valve according to claim 7, wherein the inner surface of the manifold defines a cavity and the spool is concentrically located within the cavity.

9. A servo valve according to claim 8, in which the majority of the surface of the spool is in contact, as herein defined, with the inner surface of the cavity.

10. A servo valve according to claim 1, wherein the servo valve is a direct drive valve.

11. A method of controlling a servo valve, the method comprising the steps of:
i. providing a valve including a fluid inlet, a fluid outlet and a spool having a curvilinear groove in its surface;
ii. rotating the spool from a first position in which the surface of the spool covers at least one of the fluid outlet and the fluid inlet to a second position in which the groove is aligned with the fluid inlet and the fluid outlet such that fluid flows from the fluid inlet to the fluid outlet via the groove.

12. A method of controlling a servo valve according to claim 11, wherein an additive manufacturing process is used to produce the valve.

13. A method of controlling a servo valve according to claim 11, the method further comprising the step of;
i. rotating the spool from the second position to the first position.

14. A method of controlling a servo valve according to claim 11, wherein the valve includes a second fluid inlet and a second fluid outlet and the method further comprises the step of
i. rotating the spool from the first position to a third position in which the groove is aligned with the second fluid inlet and the second fluid outlet such that fluid flows from the second fluid inlet to the second fluid outlet via the groove.

15. A method of controlling a servo valve according to claim 11, wherein the valve includes a second groove, a second fluid inlet and a second fluid outlet and the method further comprises the step of;
i. rotating the spool from the first position to a two-flow position in which each of the first and second grooves are aligned with a fluid inlet and a fluid outlet.
